(19) United States
(12) Patent Application Publication
(10) Pub. No.: US 2016/0354754 A1
(43) Pub. Date: Dec. 8, 2016

(54) SYSTEMS AND METHODS OF PLASMA PARTIAL DISSOCIATION OF CARBON DIOXIDE, WATER, AND CARBONACEOUS MATTER

(71) Applicant: Powerdyne, Inc., Newport Beach, CA (US)

(72) Inventors: Geoffrey HIRSON, Newport Beach, CA (US); Gus F. SHOUSE, Newport Beach, CA (US); Mark William SHUEY, Raleigh, NC (US)

(21) Appl. No.: 14/564,951

(22) Filed: Dec. 9, 2014

Related U.S. Application Data
(60) Provisional application No. 61/913,857, filed on Dec. 9, 2013.

(51) Int. Cl. B01J 19/08; B01D 53/04

(52) U.S. Cl. CPC B01J 19/088; B01D 53/04; B01D 2257/2045; B01D 2257/30; B01J 2219/0807; B01J 2219/0841; B01J 2219/0839; B01J 2219/0869; B01J 2219/0894; B01J 2219/0875

(57) ABSTRACT

A system for plasma partial dissociation of some materials may include one or more plasma reactors. Such materials may include one or more of carbon dioxide, hydrocarbons, and water. The plasma reactors may include anode and cathode electrodes composed of one or more metal compositions. In a method of use, the percent dissociation of the materials by the system may depend at least in part on the metal composition of the electrodes. System products composed of partial dissociation constituents of the materials may include one or more of carbon dioxide, carbon monoxide, hydrogen, oxygen, and water. The system products may be individually stored or recirculated in the system for additional product production.

### CLAIM OF PRIORITY

This application claims benefit of and priority to U.S. Provisional Application No. 61/913,857 entitled “Plasma Partial Dissociation Apparatus and Methods for Partial Dissociation of Carbon Dioxide, Water and Carbonaceous Matter” filed Dec. 9, 2013, the disclosure of which is incorporated by reference herein in its entirety.

### BACKGROUND

A significant amount of energy production in the world derives from burning hydrogen and carbon containing compounds (hydrocarbons), such as fossil fuel, coal, and natural gas. The heat energy generated from burning such material may be used to convert water to steam to make electrical energy. In addition, byproducts of such combustion may be used in specific ratios to make fuels. One such combustion byproduct is carbon dioxide (CO₂), which is a prevalent greenhouse gas.

Greenhouse gas emissions from hydrocarbon fired power and fuel plants are significant and growing rapidly. The United States has been estimated to produce close to 2 billion tons of CO₂ per year just from coal-burning power plants. Greenhouse gas emissions from coal-fired electricity, now 27% of total U.S. emissions, are projected to grow by a third by 2025.

Carbon dioxide is a stable chemical compound and does not decompose readily into its constituent matter of carbon and oxygen. Some methods for reducing carbon dioxide emissions include isolation in capture facilities and storage in deep geological layers or the ocean.

Alternative methods for removing unwanted carbon dioxide may include completely disassociating carbon dioxide into its constituents. In one example, a non-thermal plasma process and system have been developed in which carbon dioxide is dissociated into carbon and oxygen by exposing CO₂ to energized titanium dioxide rods in a reactor section. The titanium dioxide rods may have a voltage potential of about 25 kV to about 50 kV placed across them to produce 4 keV free electrons to dissociate the carbon dioxide, CO₂ having a dissociation energy of about 2.82 keV.

### SUMMARY

In an embodiment, an apparatus may be composed of a reactor vessel having an inlet and an outlet, a plasma reactor having a divergent electrode and a divergent nozzle, in which the divergent nozzle is in fluid communication with an interior of the reactor vessel, a power supply in electrical communication with the divergent electrode and the divergent nozzle and configured to apply a voltage potential across the divergent electrode and the divergent nozzle, and a plasma reactor working gas source configured to supply a working gas to the plasma reactor, in which the power supply may be configured to apply a voltage potential across the divergent electrode and the divergent nozzle to partially dissociate the working gas.

In an embodiment, a method may include providing an apparatus composed of a reactor vessel having an inlet and an outlet, a plasma reactor having a divergent electrode and a divergent nozzle, in which the divergent nozzle is in fluid communication with an interior of the reactor vessel, a power supply in electrical communication with the divergent electrode and the divergent nozzle, and a plasma reactor working gas source. Additionally, the method may include introducing the working gas from the working gas source into the plasma reactor, adjusting the power supply to apply a voltage potential across the divergent electrode and the divergent nozzle, thereby causing the working gas to partially dissociate and generate a plasma comprising a plurality of constituents within the reactor vessel, causing the plurality of constituents to exit the reactor vessel through the outlet, storing a first portion of the plurality of constituents in one or more constituent storage devices, circulating a second portion of the plurality of constituents into the inlet of the reactor vessel, and contacting the second portion of the plurality of constituents with the plasma.

In another embodiment, a method may include providing a first apparatus composed of a first reactor vessel having a first inlet and a first outlet, a first plasma reactor having a first divergent electrode and a first divergent nozzle, in which the first divergent nozzle is in fluid communication with an interior of the first reactor vessel, a first power supply in electrical communication with the first divergent electrode and the first divergent nozzle, and a first plasma reactor working gas source. The method may also include providing a second apparatus composed of a second reactor vessel having a second inlet and a second outlet, in which the second inlet is in fluid communication with the first outlet and the second outlet is in fluid communication with the first inlet, a second plasma reactor having a second divergent electrode and a second divergent nozzle, in which the second divergent nozzle is in fluid communication with an interior of the second reactor vessel, a second power supply in electrical communication with the second divergent electrode and the second divergent nozzle, and a second plasma reactor working gas source. The method may further include providing a feed chamber in fluid communication with the first outlet and the second inlet, introducing a first working gas from the first working gas source into the first plasma reactor, introducing a second working gas from the second working gas source into the second plasma reactor, adjusting the first power supply to apply a first voltage potential across the first divergent electrode and the first divergent nozzle, thereby causing the first working gas to partially dissociate and generate a first plasma comprising a first plurality of constituents within the first reactor vessel, adjusting the second power supply to apply a second voltage potential across the second divergent electrode and the second divergent nozzle, thereby causing the second working gas to partially dissociate and generate a second plasma comprising a second plurality of constituents within the second reactor vessel, causing the first plurality of constituents to exit the first reactor vessel through the first outlet, introducing a carbonaceous material into the feed chamber, circulating a portion of the first plurality of constituents into the feed chamber, thereby contacting the carbonaceous material with the first plurality of constituents to form a gaseous mixture, and circulating the gaseous mixture into the second reactor vessel, thereby contacting the gaseous mixture with the second plasma to form an enriched mixture.

### BRIEF DESCRIPTION OF THE DRAWINGS

FIG. 1 depicts a cross-section of an embodiment of a plasma reactor in accordance with the present disclosure.

FIG. 2 depicts a cross-section of an embodiment of a plasma reactor illustrating some components thereof in accordance with the present disclosure.

FIG. 3A depicts an embodiment of a reactor vessel incorporating a plasma reactor in accordance with the present disclosure.

FIGS. 3B-3F depict embodiments of plasma array orientations within a reactor vessel in accordance with the present disclosure.

FIG. 4 depicts an embodiment of a pair of plasma reactors having opposing electrical polarity in accordance with the present disclosure.

FIG. 5 depicts an embodiment of an apparatus for partial dissociation of gases in accordance with the present disclosure.

FIG. 6 depicts an embodiment of a process controller in accordance with the present disclosure.

FIG. 7 depicts an embodiment of an apparatus for partial dissociation of gases and carbonaceous materials in accordance with the present disclosure.

FIG. 8 is a flow diagram of an illustrative method for partial dissociation of gases in accordance with the present disclosure.

FIG. 9 is a flow diagram of an illustrative method for partial dissociation of gases and carbonaceous materials in accordance with the present disclosure.

### DETAILED DESCRIPTION

As disclosed above, a non-thermal plasma process may result in complete dissociation of carbon dioxide to form its constituents of carbon and oxygen. In some embodiments, titanium dioxide rods having a voltage difference therebetween of about 25 kV to about 50 kV may be used to completely dissociate CO₂. While complete dissociation of carbon dioxide into carbon and oxygen may be one method to remove CO₂ from industrial processes, the energy cost for doing so may be unacceptable. Less energy may be used by methods and devices that cause only partial dissociation of CO₂ and other gases.

In addition to saving energy costs that may be associated with systems designed for complete CO₂ dissociation, systems and methods using partial dissociation processes may produce a number of industrially useful constituents. In some non-limiting examples, partial dissociation of a combination of water and carbon dioxide may result in carbon monoxide, oxygen, and hydrogen, in addition to unreacted carbon dioxide and water. Carbon monoxide and hydrogen may be used to form syngas, a starting mixture in the synthesis of a number of fuel types. Hydrogen may be used in fuel cells. Oxygen may be stored for a variety of medical and industrial uses. Because of the variety of gases produced under partial dissociation conditions, it may be useful to provide a single system that can be readily adapted to produce specific or preferred byproducts or amounts of such byproducts of partial dissociation.

In some non-limiting embodiments, a system for partial dissociation of one or more working gases may include a plasma reactor (such as a plasma torch) and a reactor vessel that may contain at least the plasma reactor field produced by the plasma reactor acting on a working gas. The reactor vessel may be placed in fluid communication with any of a number of devices that may process and control the one or more constituents produced by the plasma reactor field. Some non-limiting examples of such devices may include heaters, coolers, gas filters, particulate filters, and storage devices. In one non-limiting example, the processed output of the reactor vessel may be returned in whole or in part to the reactor vessel for additional heating and reacting with the plasma therein. In another non-limiting example, the constituents produced by the plasma reactor may be reacted with other materials, such as waste carbonaceous materials, to produce additional constituents in a gas stream. In another non-limiting example, the additional constituents in the gas stream may contact a second plasma field generated by a second plasma reactor.

The types of constituents—or the relative amounts thereof—produced by a plasma reactor field may depend on several process variables. In some non-limiting examples, the types and/or amounts of the constituents may depend on the composition of the working gas supplied to the plasma reactor. In another non-limiting example, the types and/or amounts of the constituents may depend on a value or polarity of a voltage difference placed across electrodes that compose the plasma reactor. In yet another non-limiting example, the types and/or amounts of the constituents may depend on a material composition of the electrodes that compose the plasma reactor. In still another non-limiting example, the types and/or amounts of the constituents may depend on the size of the electrodes that compose the plasma reactor.

Although specific configurations of plasma reactors, reactor vessels, and other system components and methods for partial dissociation of gases are disclosed in detail below and in the figures referenced herein, it may be recognized that such systems and methods using such systems are only embodiments and examples, and are not considered to limit the scope of the invention disclosed herein.

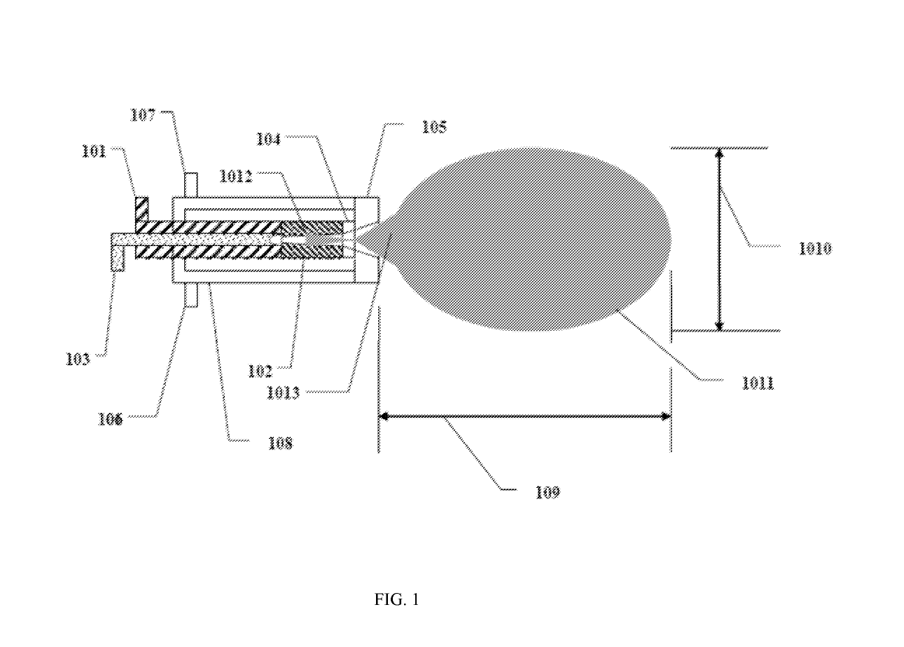

FIG. 1 depicts a plasma reactor 108 in a cross-sectional view, illustrating non-limiting examples of some internal parts thereof. It may be recognized that a plasma reactor 108 may include a plasma torch as one non-limiting embodiment. Electrical power may be supplied to the plasma torch 108 by a power tube 101. The electrical power may be used to create a voltage potential across an electrode (cathode) 102 and a nozzle (anode) 105. In some embodiments, the electrode 102 may have a positive polarity with respect to the nozzle 105. Water, for temperature control, may be supplied to the plasma torch by means of a cooling tube 103. The cooling tube 103 may be used to regulate the temperature of the electrode 102 and the power tube 101.

The plasma torch 108 may receive one or more working gases that may be ionized into a plasma 1011, 1012, and 1013 as a result of being exposed to the voltage potential across the electrode 102 and the nozzle 105. The plasma 1011, 1012, and 1013 may be composed of constituents derived from the partial dissociation of the working gas. The working gas may include carbon dioxide supplied from a carbon dioxide source 107. The carbon dioxide may be supplied in a dry form or a humidified form. As one non-limiting example, humidified carbon dioxide may be produced by bubbling carbon dioxide through water. The working gas may also be composed of a combination of carbon dioxide and water. In one non-limiting example, the carbon dioxide and water may be pre-mixed in any appropriate combination and supplied as a single gas stream. In another non-limiting example, carbon dioxide may be supplied from a carbon dioxide source 107 and water, as steam, may be supplied separately from a water source 106.

A plasma arc 1012 may be initially formed by the plasma torch 108 by the voltage field potential created between the electrode 102 and the nozzle 105. A gas ring 104 having gas holes may be placed between the electrode 102 and the nozzle 105, forming a pinch-point therebetween. The plasma arc 1012 may be restricted at the pinch point, and may be emitted at a distal side of the gas ring 104 to form a plasma discharge 1013. The plasma discharge 1013 may then expand to form an expanded plasma field 1011. Although the plasma field volume may dissipate at its outer surface, the centerline plasma may form the hottest region. As a result, the plasma field 1011 may take on an elliptical shape having a center axis. The plasma field 1011 may have a plasma field length 109 of about 0.01 meters to about 10 meter and a plasma field width 1010 of about 0.4 meters to about 0.6 meters. Non-limiting examples of a plasma field length 109 may include a length of about 0.01 meters, about 0.03 meters, about 0.05 meters, about 0.1 meter, about 0.3 meters, about 0.5 meters, about 1 meter, about 3 meters, about 5 meters, about 10 meters, or any value or range between any two of these values including endpoints. Non-limiting examples of a plasma field width 1010 may include a width of about 0.4 meters, about 0.42 meters, about 0.44 meters, about 0.46 meters, about 0.48 meters, about 0.5 meters, about 0.52 meters, about 0.54 meters, about 0.56 meters, about 0.58 meters, about 0.6 meters, or any value or range between any two of these values including endpoints.

In one embodiment, the working gas may be carbon dioxide, and the expanded plasma field 1011 may be composed of the partially dissociated constituents of carbon dioxide (CO₂). Such constituents may include one or more of CO₂, carbon monoxide (CO), and oxygen gas (O₂) in any combination or ratio. In another embodiment, the working gas may be humidified carbon dioxide or a mixture of carbon dioxide and water. An expanded plasma field 1011 resulting from such a working gas may be composed of the partially dissociated constituents of carbon dioxide (CO₂) and water (H₂O). Such constituents may include one or more of CO₂, CO, O₂, hydrogen (H₂), and water (H₂O) in any combination or ratio. In some non-limiting examples, the amounts of the partially dissociated constituents may depend at least in part on the polarity or voltage potential placed across the electrode 102 and the nozzle 105 of the plasma reactor 108. In some other non-limiting examples, the amounts and/or types of the partially dissociated constituents may depend at least in part on the composition of the electrode 102, the nozzle 105, or both the electrode and the nozzle of the plasma reactor 108.

In some embodiments, the plasma reactor 108 may have a CO₂ dissociation efficiency of around 60% and produce an expanded plasma field 1011 having a plasma surface temperature of about 3000° K. In some other embodiments, the plasma reactor 108 may have a CO₂ dissociation efficiency of around 50% and produce an expanded plasma field 1011 having a plasma surface temperature of about 2900° K.

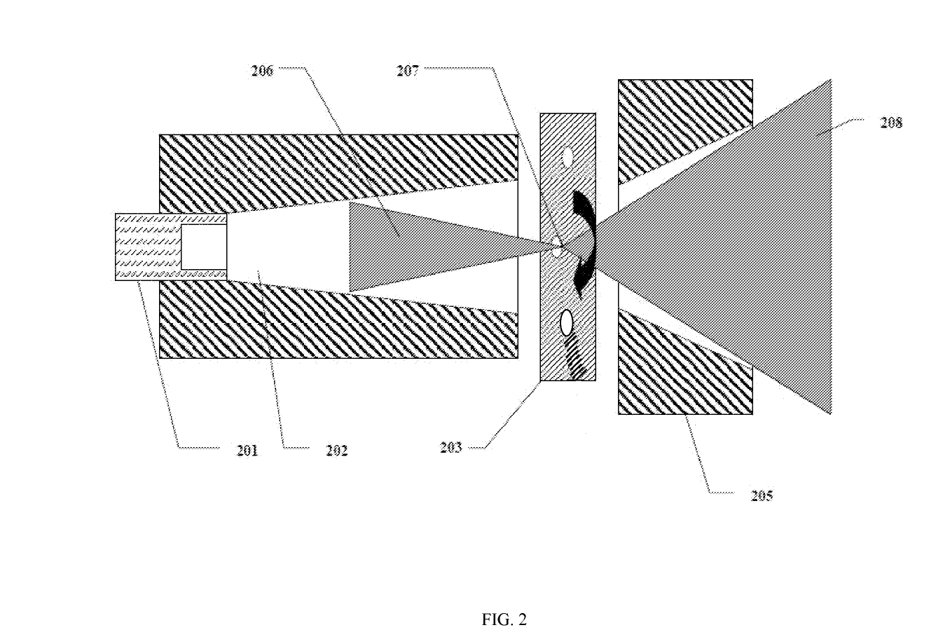

FIG. 2 depicts an expanded cross-section of an embodiment of the plasma reactor depicted in FIG. 1. The electrode 202 and nozzle 205 may each have a geometrically divergent cross section. A divergent-diameter ratio may be defined as the ratio of the smallest diameter of a component (such as the electrode 202 and the nozzle 205) to its largest diameter. As depicted in FIG. 2, the smallest diameter of the electrode 202 and the nozzle 205 may be found at their respective proximal ends, while the largest diameter may be found at their respective distal ends. In some embodiments, the electrode 202 may have a divergent-diameter ratio of about 1.5 to about 2.0. Non-limiting examples of a divergent-diameter ratio of the electrode 202 may include a ratio of about 1.5, about 1.6, about 1.7, about 1.8, about 1.9, about 2.0, or any value or range between any two of these values including endpoints. In some embodiments, the nozzle 205 may have a divergent-diameter ratio of about 2.0 to about 2.5. Non-limiting examples of a divergent-diameter ratio of the nozzle 205 may include a ratio of about 2.0, about 2.1, about 2.2, about 2.3, about 2.4, about 2.5, or any value or range between any two of these values including endpoints.

In addition, FIG. 2 depicts an enlarged view of an end of the cooling tube 201, the electrode 202, a gas ring 203 having a hole or pinch point 207, and the nozzle 205. A CO₂ plasma arc 206 may be formed between the electrode 202 and the pinch point 207 placed between the electrode and the nozzle 205. The CO₂ gas flowing through the pinch point 207 will emanate tangentially to the axis of the plasma arc 206. The tangential CO₂ gas flow may cause to CO₂ plasma arc 206 to be compressed at the pinch point 207 thereby causing the plasma arc to rotate (a phenomenon also referred to as a “plasma swirl flow”). The rotation of the plasma arc 206 may result in plasma arc stability, thereby decreasing the wear on the electrode 202, gas ring 203, and nozzle 205. On the distal side of the pinch point 207, the plasma arc 206 may rotate and expand 208 to form the full plasma field.

One or more of the electrode 202, the gas ring 203, and the nozzle 205 may be independently made from one or more materials capable of maintaining the voltage potential field and withstanding the temperature of the plasma. Some non-limiting examples of such materials may include nickel, tantalum, tungsten, graphite, or any combination thereof including mixtures, coatings, and alloys. In some non-limiting embodiments, the electrode 202 may have a width of about 0.5 inches (about 1.2 cm) to about 6 inches (about 15 cm). Non-limiting examples of the electrode width may include about 0.5 inches (about 1.2 cm), about 1 inch (about 2.5 cm), about 1.5 inches (about 3.8 cm), about 2 inches (about 5 cm), about 2.5 inches (about 6.2 cm), about 3 inches (about 7.5 cm), about 3.5 inches (about 8.8 cm), about 4 inches (about 10 cm), about 4.5 inches (about 11.2 cm), about 5 inches (about 12.5 cm), about 5.5 inches (about 13.8 cm), about 6 inches (about 15 cm), or any value or range between any two of these values including endpoints.

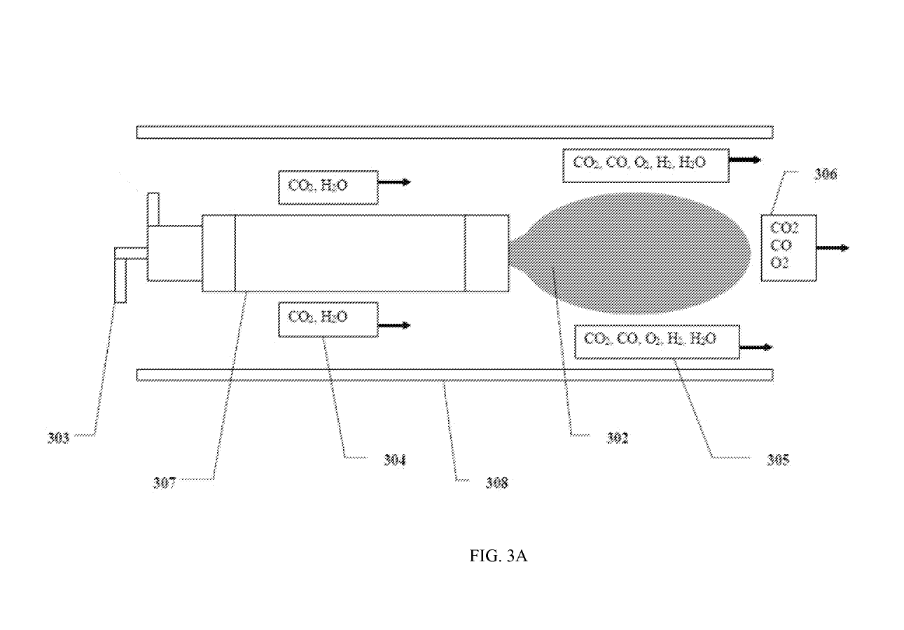

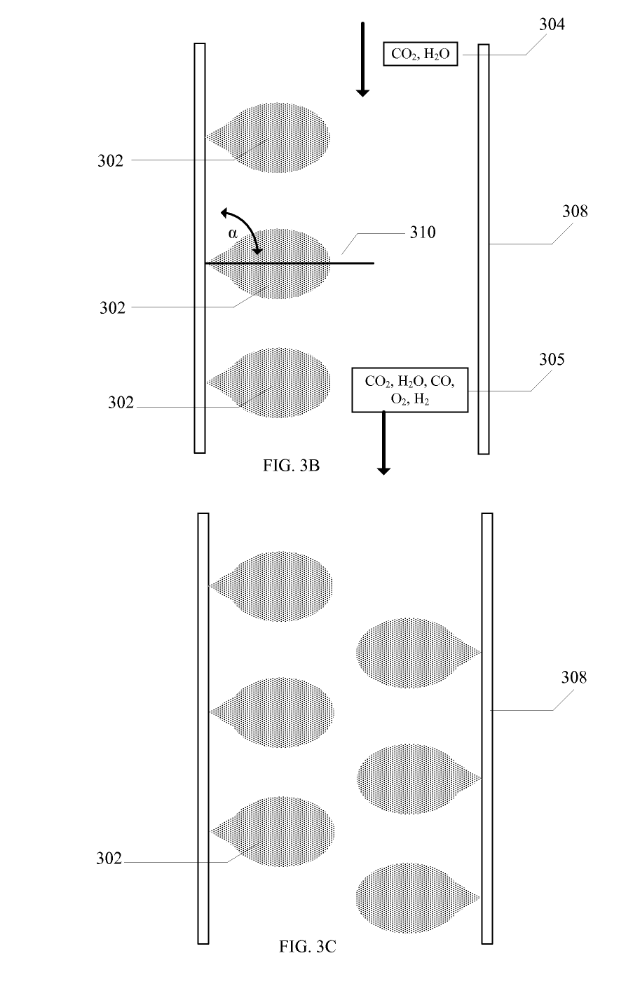

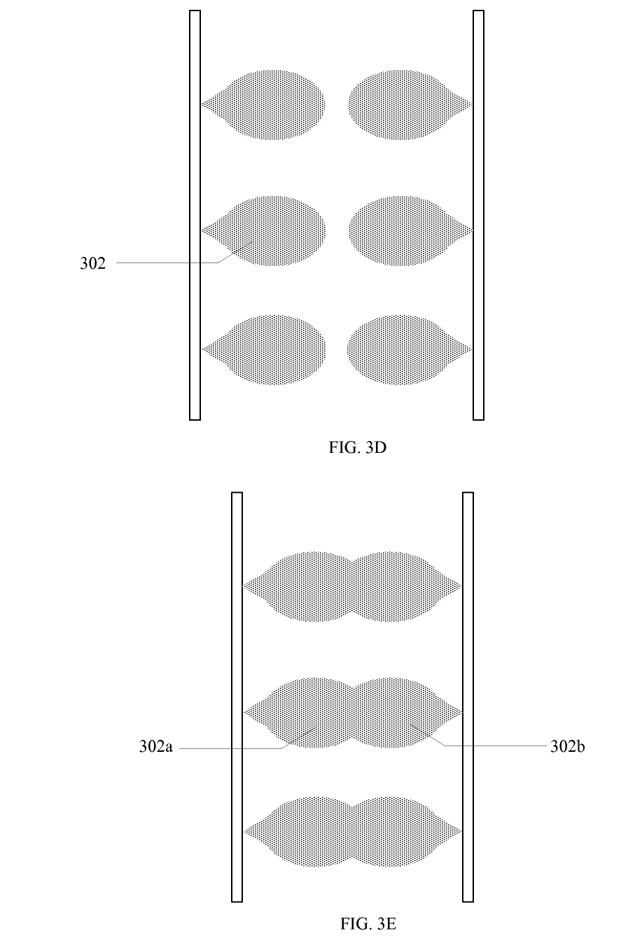

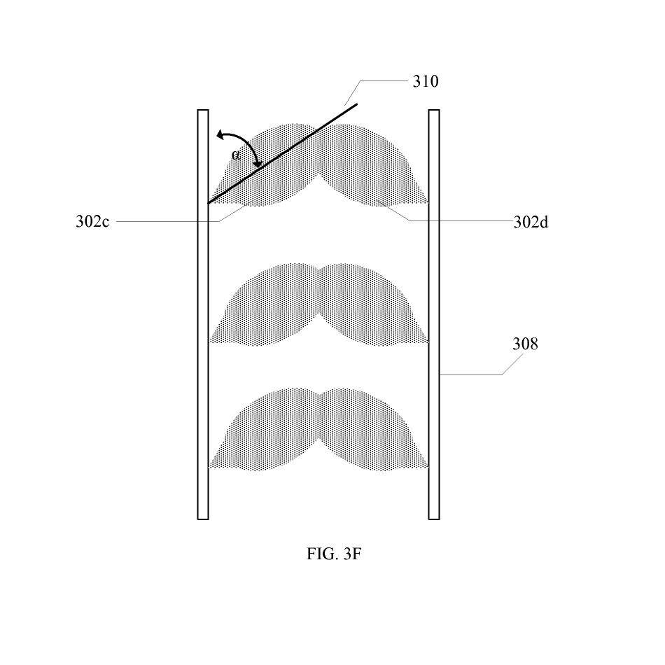

FIG. 3A depicts one non-limiting embodiment of a system that can use a plasma reactor 307 to create constituents 305 and 306 from the partial dissociation of the plasma reactor working gas.

As depicted in FIG. 3A, a plasma reactor 307 may be placed in a reactor vessel 308 so that a length-wise axis of the plasma reactor is approximately co-axial with or parallel to a length-wise axis of the reactor vessel. In one non-limiting embodiment, the reactor vessel 308 may comprise a cylindrical, double-walled, water-cooled steel vessel. The orientation of the length-wise axis of the plasma reactor 307 may cause the expanded plasma field 302 generated thereby to have a length-wise axis also approximately co-axial with or parallel to the length-wise axis of the reactor vessel 308. Such a geometry may permit additional gases 304 entering the reactor vessel 308 to flow past and through the expanded plasma field 302 and thereby contribute their partially dissociated compounds 305 to the overall effluent.

In one non-limiting example, the working gas 303 may be composed of carbon dioxide (CO₂). Partial dissociation constituents 306 created by the plasma reactor 307 from such a working gas 303 may include CO, O₂, and un-reacted CO₂. In another non-limiting example, the working gas 303 may be composed of humidified CO₂ or a combination of CO₂ and water (H₂O), for example as steam. Alternatively, additional gases 304 may be introduced into the reactor vessel 308 through one or more dedicated inlet ports and pass through the expanded plasma field 302. Such additional gases 304 may also include one or more of H₂O and CO₂ in any appropriate combination. The interaction of the additional gases 304 with the expanded plasma field 302 may result in partial dissociation constituents 305 that may include CO, O₂, un-reacted CO₂, H₂ and unreacted H₂O. It may be recognized that a plasma reactor 307 having a working gas 303 that includes both CO₂ and H₂O may also produce partial dissociation constituent 305 (including CO, O₂, un-reacted CO₂, H₂ and unreacted H₂O).

FIGS. 3B-3F present some non-limiting embodiments of a plurality of plasma reactors that may form a plasma array within a reactor vessel.

FIG. 3B depicts an embodiment in which the body of one or more plasma reactors (not shown) are external to the reactor vessel 308. The nozzles of the plasma reactors may be in fluid communication with the interior of the reactor vessel 308 so that the expanded plasma field 302 of each of the one or more plasma reactors may be directed into the reactor vessel. As disclosed above with respect to FIG. 3A, the working gas of the plasma reactors may be CO₂ or a combination of CO₂ and H₂O. Constituents 305 of the resulting plasma fields 302 may include CO, O₂, and un-reacted CO₂, if only CO₂ is used as the working gas. Constituents 305 of the resulting plasma fields 302 may include CO, O₂, un-reacted CO₂, H₂ and unreacted H₂O if a combination of CO₂ and H₂O is used as the working gas. Alternatively, additional gases 304, such as CO₂ and H₂O in any amount or ratio, may be added separately into the reactor vessel 308. Contacting the additional gases 304 with the expanded plasma fields 302 may also result in partial dissociation constituents 305 including CO, O₂, un-reacted CO₂, H₂ and unreacted H₂O.

In the embodiment depicted in FIG. 3A, a length-wise axis of the expanded plasma field 302 may be directed approximately co-axial with or parallel to the length-wise axis of the reactor vessel 308. In FIG. 3B, the length-wise axis 310 of the expanded plasma field 302 may be directed in a different orientation with respect to the length-wise axis of the reactor vessel 308. In some embodiments, the length-wise axis 310 of the expanded plasma field 302 may form some angle α with respect to the axis of the reactor vessel 308 or with respect to an interior surface thereof. For example, FIGS. 3B-3E depict expanded plasma fields 302 from a plurality of plasma reactors that have their respective length-wise axes 310 each forming an angle α of about 90° with respect to an interior surface of the reactor vessel 308.

FIGS. 3B-3F also depict some non-limiting examples of plasma reactor arrays. Such arrays may be formed from a plurality of plasma reactors, each plasma reactor directing its expanded plasma field 302 into the interior of a reactor vessel 308. Such plasma reactor arrays may include 2 to about 9 plasma reactors. Non-limiting examples of a number of plasma reactors may include 2 reactors, 3 reactors, 4 reactors, 5 reactors, 6 reactors, 7 reactors, 8 reactors, or 9 reactors. FIG. 3B depicts a reactor array comprising a line of plasma reactors that may extend along just one side of a reactor vessel 308. FIG. 3C depicts another non-limiting example in which the line of plasma reactors may form a spiral or helical arrangement about a length-wise axis of the reactor vessel 308. FIG. 3D depicts a plurality of rings of plasma reactors having their expanded plasma fields 302 directed towards each other. Such rings of plasma reactors may include two opposing reactors, three reactors, four reactors, or any number of plasma reactors. FIG. 3E depicts a plurality of rings of plasma reactors in which the plasma reactors in a ring are configured to allow their expanded plasma fields 302 to contact each other. For example, a first plasma reactor and a second plasma reactor may be included in the same ring of plasma reactors, and may have at least some portion of the first plasma reactor field 302a contact at least a portion of the second plasma reactor field 302b. FIG. 3F depicts a similar arrangement of plasma reactors as those depicted in FIG. 3E, except that the length-wise axis 310 of each of the expanded plasma fields 302 forms an acute angle α with respect to an interior surface of the reactor vessel 308. In some non-limiting embodiments, angle α may be an acute angle of about 5° to about 85°. Non-limiting examples of angle α may include an acute angle of about 5°, about 10°, about 15°, about 20°, about 25°, about 30°, about 35°, about 40°, about 45°, about 50°, about 55°, about 60°, about 65°, about 70°, about 75°, about 80°, about 85°, or any value or range between any two values including endpoints. It may be understood that an “acute angle” may refer to an angle made by the length-wise axis 310 of each of the expanded plasma fields with respect to either an inlet side of the reactor vessel or an outlet side of the reactor vessel. As depicted in FIG. 3F, opposing plasma reactors may be disposed so that their expanded plasma fields (for example, plasma field 302c and 302d) may overlap. It may be understood that a plasma field angle α of one plasma field 302 may be the same as or different from the plasma field angle α of another plasma field.

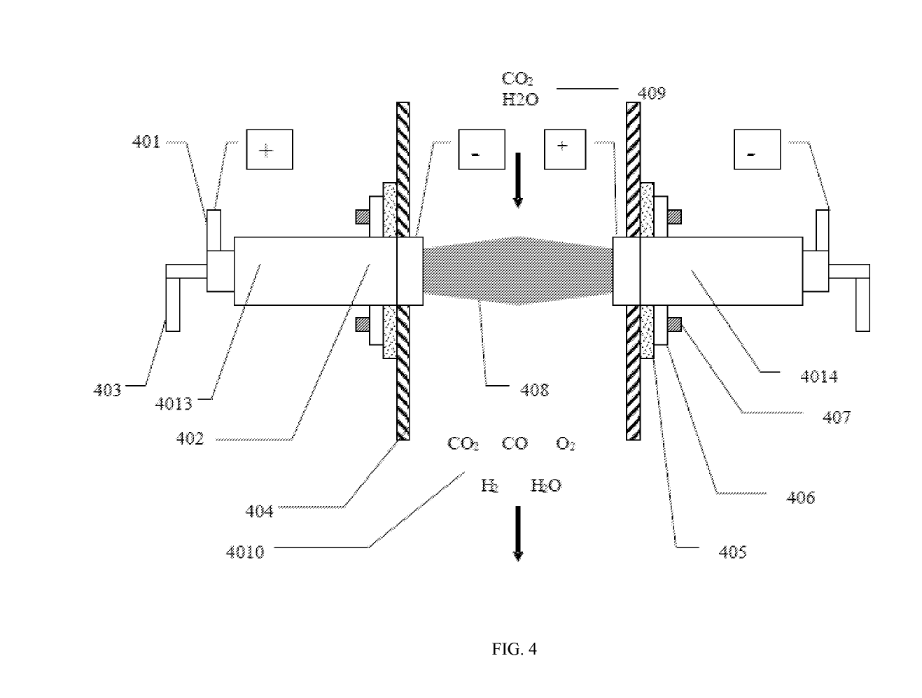

FIG. 4 depicts another embodiment of a system having at least two CO₂ plasma reactors 4013 and 4014 configured to permit their respective expanded plasma fields 408 to merge (compare with FIGS. 3E and 3F). FIG. 4 depicts one plasma reactor 4013 having power tube 401 and cooling tube 403 as disclosed above with respect to FIG. 1. Although such constituents are unlabeled with respect to the second plasma reactor 4014, it may be understood that similar constituents may be associated with the second plasma reactor as well. In addition, FIG. 4 depicts one embodiment of a method of mounting a plasma reactor with respect to a reactor vessel 404 so that the plasma reactor body may be external to the reaction vessel and the expanded plasma 408 may be maintained within an interior of the reaction vessel. Thus, in FIG. 4, plasma reactor 4014 may be affixed to a double-walled, water-cooled steel reaction vessel 404 by means of an isolation flange 405, a steel flange 406 and a bolt assembly 407. Although such mounting components are unlabeled with respect to the first plasma reactor 4013, it may be understood that similar mounting components may be associated with the first plasma reactor as well.

FIGS. 3E and 3F depict a ring configuration of plasma reactors configured to contact their respective expanded plasma fields with each other. Although not shown in FIGS. 3E and 3F, the electrode and nozzle of each plasma reactor may support a voltage potential having the same polarity (that is, the electrode of each plasma reactor may have a positive polarity with respect to the nozzle of that plasma reactor). FIG. 4, however, depicts an alternative configuration in which the electrode and nozzle of the first plasma reactor 4013 may have a first polarity and the electrode and nozzle of the second plasma reactor 4014 may have a second and opposite polarity. As a non-limiting example, a first plasma reactor 4013 may be configured to have a first electrode at a positive electrical potential with respect to a first nozzle, while a second plasma reactor 4014 may be configured to have a second electrode at a negative electrical potential with respect to a second nozzle. In this manner, the first plasma reactor 4013 may transfer its expanded plasma field 408 to the second plasma reactor 4014. The combined expanded plasma fields 408 of the plasma reactors 4013 and 4014 may form a combined plasma field of about 1.5 meters to about 2 meters in length. The combined plasma field 408 may have a maximum width of about 0.2 meters to about 0.3 meters.

As disclosed above, the expanded plasma field from a plasma reactor may have constituents such as CO, CO₂, and O₂ derived from the partial dissociation of a CO₂ working gas by the plasma reactor. Alternatively, if the working gas is composed of water added to the CO₂ or humidified CO₂, the resulting constituents may also include H₂O and H₂ 4010. Additional CO₂ and H₂O from processing CO₂ or humidified CO₂ may be recirculated 409 back through the expanded plasma field 408. Recirculated material or newly introduced gases 409 may further be partially dissociated upon contact with the expanded plasma field 408.

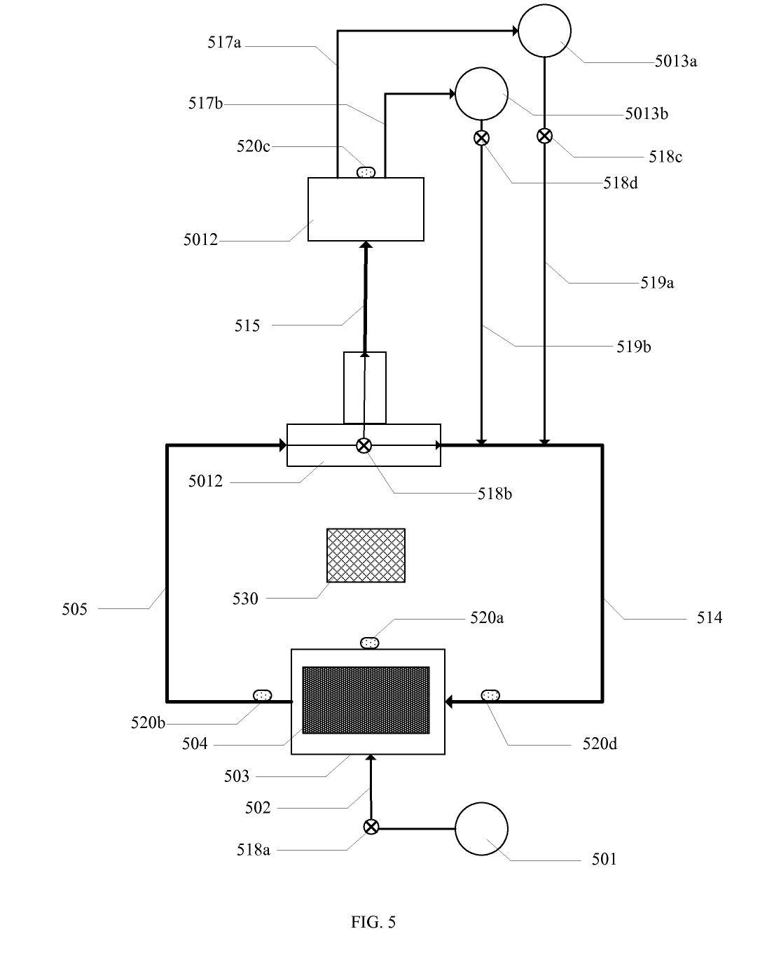

FIG. 5 depicts a non-limiting embodiment of a system that may use a plasma reactor configured for partial dissociation of a working gas composed of carbon dioxide and water.

The system may be composed of a reactor vessel 503 configured to contain the expanded plasma fields of one or more plasma reactors 504. The one or more plasma reactors 504 may be configured as individual plasma reactors (for example, as depicted in FIG. 3A) or as an array of plasma reactors as depicted in FIGS. 3B-3F or FIG. 4. It may be recognized that figures presented herein are intended for illustrative purposes only and are not limiting with respect to the possible configuration of any one or more plasma reactors in such a system.

Each plasma reactor 504 may be supplied by a working gas from a working gas supply 501. The working gas may be delivered to the one or more plasma reactors 504 by means of an appropriate delivery system that may be composed of any number of pipes 502, manifolds, valves 518a, or other components as are known to one having ordinary skill in the art of gas metering and delivery. In one non-limiting embodiment, the working gas may be composed of carbon dioxide. The carbon dioxide may be supplied as a dry gas or as a humidified gas (that is, gas that has been exposed to water). In another non-limiting example, the working gas may be composed of a mixture of carbon dioxide and water steam.

The working gas may be delivered to the one or more plasma reactors 504. The plasma reactors 504 may be electrically connected to one or more power supplies (not shown) so that a voltage potential is induced across the electrode and nozzle of each plasma reactor. Exposure of the working gas to the voltage potential may cause the working gas to form an expanded plasma field composed of partially dissociated constituents of the working gas. The one or more power supplies may supply a power of about 200 kW to about 1 MW across the electrode and nozzle of each plasma reactor. Non-limiting examples of the power supplied by the one or more power supplies may be about 200 kW, about 400 kW, about 600 kW, about 800 kW, about 1 MW, or any value or range between any two values including endpoints. The reactor vessel 503 may have at least one inlet and one outlet. The inlet may be configured to receive the partial dissociation constituents of the working gas. In some embodiments, the partial dissociation constituents may be composed of CO₂, CO, and O₂. In some other embodiments, the partial dissociation constituents may be composed of H₂, H₂O, CO₂, CO, and O₂. The partial dissociation constituents may leave the reactor vessel 503 via the at least one outlet and may traverse a first refractory lined pipe section 505, which may include any form of pipe. In some embodiments, the first refractory lined pipe section 505 may include one or more processing stages, such as, without limitation, chillers, particulate traps, water recovery devices, and other material processing stages.

One such gas processing stage may include a diverter 5012. The diverter 5012 may be configured to direct portions of the partial dissociation constituents to different destinations. The diverter 5012 may include at least one valve 518b that may control both the direction of the partial dissociation constituents as well as the amount of the partial dissociation constituents directed to their destinations. Although diverter 5012 is depicted in FIG. 5 as having two output sides, it may be recognized that a diverter may direct the partial dissociation constituents to any number of destinations.

In one embodiment, the diverter 5012 may direct at least a portion of the partial dissociation constituents to a second refractory lined pipe section 514. The second refractory lined pipe section 514 may be in fluid communication with at least one inlet of the reactor vessel 503. In this manner, a portion of the partial dissociation constituents generated in the reactor vessel 503 may be returned to the reactor vessel and may contact the expanded plasma fields of the plasma reactors 504 for additional plasma treatment.

In another embodiment, the diverter 5012 may direct at least a portion of the partial dissociation constituents to one or more additional refractory lined pipe sections 515. In one non-limiting embodiment, the one or more additional refractory lined pipe sections 515 may direct the portion of the partial dissociation constituents to one or more separators 5012. The one or more separators 5012 may include, without limitation, one or more molecular separators, membrane filters, or sieves. The one or more separators 5012 may separate the partial dissociation constituents into individual species including, without limitation, carbon dioxide, carbon monoxide, hydrogen gas, water, and oxygen gas. The individual species may be transferred along any number of pipes 517a, 517b to one or more storage devices 5013a, 5013b, respectively. The stored species may find any number of uses. In some examples, carbon monoxide and hydrogen gas may be combined in any appropriate mixture to form syngas which may be used to produce hydrocarbon products including, without limitation, diesel fuel, naphtha and wax. In other examples, hydrogen may be used to create fuel cells. In still other examples, oxygen may be supplied for industrial applications (for example as an oxidant for oxyacetylene torches) or for health care applications (for example, for hospital oxygen supplies).

In still another example, some of the individual species may be returned through the second refractory lined pipe section 514 to the reactor vessel 503 for additional processing. The individual species may be metered by means of one or more valves 518c, 518d and directed along return pipes 519a and 519b, respectively.

It may be recognized that a system as depicted in FIG. 5 may require process control automation to optimize the conditions and amounts of materials throughout. Such process control automation may include any number of sensors such as sensors 520a-520d. Some sensors 520a may be associated with the reactor vessel 503 and may be used to sense one or more process variables including reactor vessel pressure, temperature, and the composition of the partial dissociation constituents generated therein. Some sensors 520b may monitor the temperature and composition of constituents exiting the reactor vessel 503. Some sensors 520c may be used to monitor the composition of species resulting from the one or more separators 5012 to determine the efficiency of species separation. Other sensors 520d may monitor the conditions of any gas or species returned to the reactor vessel 503. It may be understood that such sensors as depicted in FIG. 5 are non-limiting, as sensors may be associated with any one or more system components as disclosed herein and may sense any number of appropriate process variables.

In addition to a variety of sensors, the system as depicted in FIG. 5 may also include any number of actuators to provide automated control of system components. Without limitation, such actuators may be used to control one or more valves 518a that may meter an amount of working gas supplied to the one or more plasma reactors 504, one or more power supplies for the one or more plasma reactors, one or more valves 518b to adjust the amounts of constituents flowing through the diverter 5012, one or more valves 518c, 518d to meter the amounts of individual species returned to the reactor vessel 503 from storage devices, such as 5013a, and 5013b, respectively, or any other controllable device within the system. The actuators may be configured to receive control data from the controller to direct their operations.

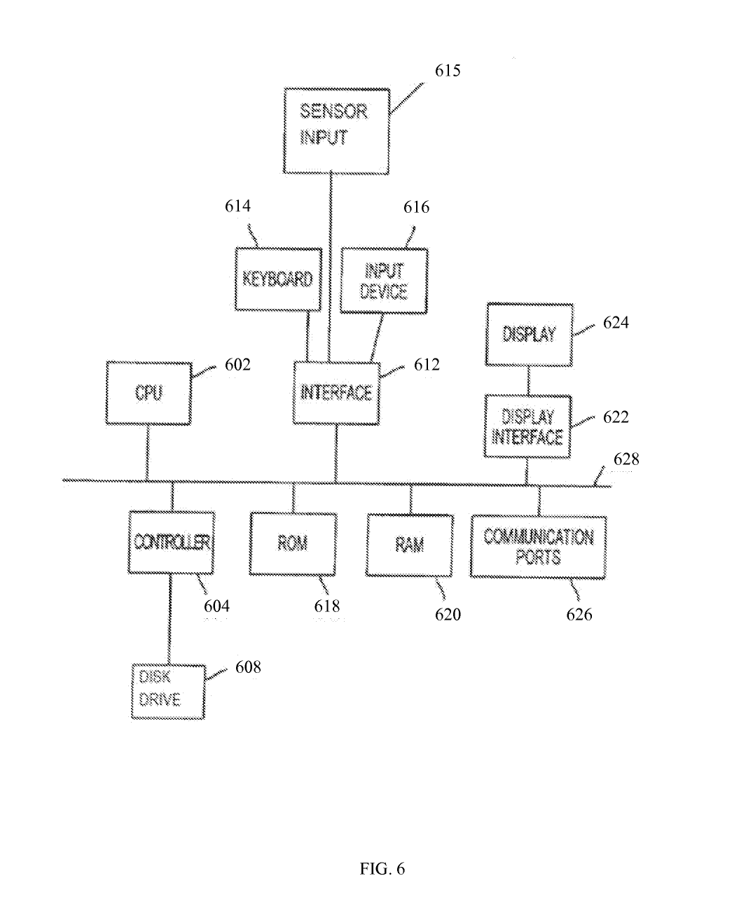

The sensors 520a-520d and the actuators may all be in data communication with one or more controllers 530. FIG. 6 depicts one non-limiting example of such a controller 530. A bus 628 may serve as the main information highway interconnecting the other illustrated components of the hardware. CPU 602 is a processor, the central processing unit of the system that performs calculations and logic operations required to execute a program. CPU 602, alone or in conjunction with one or more of the other elements disclosed in FIG. 6, is a processing device, computing device or processor as such terms are used within this disclosure. Read only memory (ROM) 618 and random access memory (RAM) 620 constitute examples of memory devices.

A memory controller 604 provides an interface between one or more optional tangible, computer-readable memory devices 608 and the system bus 628. These memory devices 608 may include, for example, an external or internal DVD or CD ROM drive, a hard disk drive, flash memory, a USB drive or the like. As indicated previously, these various drives 608 and memory controllers 604 are optional devices. Additionally, the memory devices 608 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the methods and systems as discussed above may be stored in the ROM 618 and/or the RAM 620. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 622 may permit information from the bus 628 to be displayed on the display 624 in audio, visual, graphic or alphanumeric format. The information may include information related to a current job ticket and associated tasks. Communication with external devices may occur using various communication ports 626. An exemplary communication port 626 may be attached to a communications network, such as the Internet or an local area network.

The hardware may also include an interface 612 which allows for receipt of data from input devices such as a keyboard 614 or other input device 616 such as a mouse, a joystick, a touch screen, a remote control, a pointing device, a video input device and/or an audio input device. Data derived from the sensors may be received by a sensor input interface 615. The actuators may receive control data through the communication ports 626 or through additional output interfaces including, without limitation, serial interfaces, parallel interfaces, wireless interface, and optical interfaces.

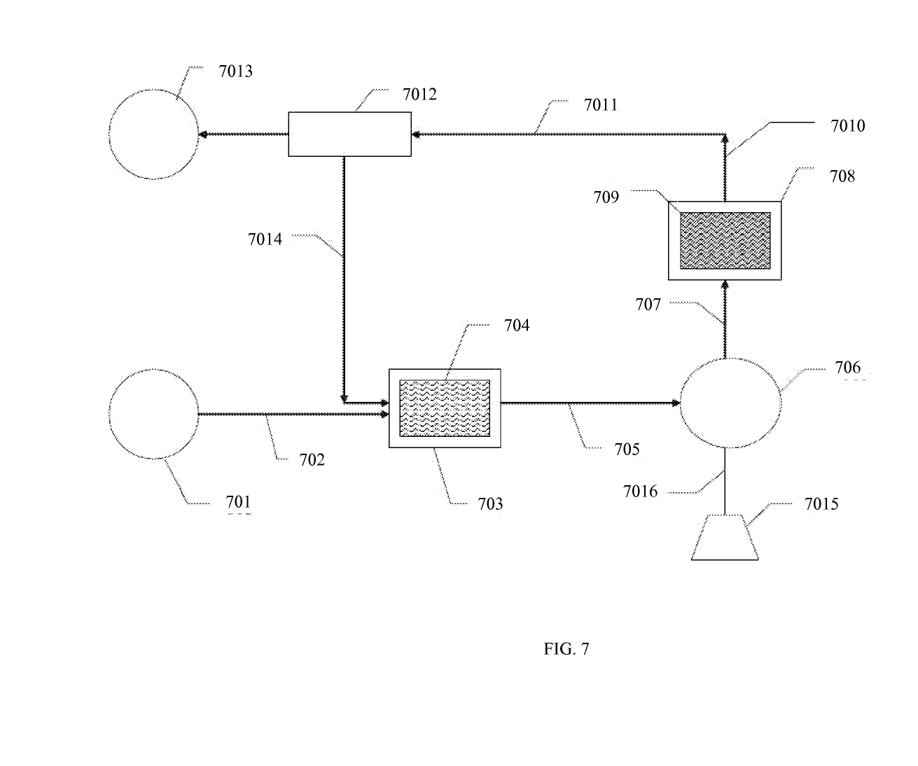

FIG. 7 depicts an example of a second system that includes a plurality of reactor vessels 703 and 708 designed to form partial dissociation constituents from CO₂, humidified CO₂, water, and carbonaceous matter. Carbon dioxide stored in storage tank 701 may flow though gas pipe 702 into a first plasma reactor array 704 which may be composed of a plurality of individual plasma reactors. In some embodiments, each of the plasma reactors in the plasma reactor array 704 may receive about the same amount of gas flow. In some non-limiting examples, the plasma reactors may receive a gas flow of about 10 standard cubic feet per minute (scfm) (4.72×10⁻³ m³/sec) to about 60 scfm (28.3×10⁻³ m³/sec). Non-limiting examples of such gas flow may include, without limitation, about 10 scfm (4.72×10⁻³ m³/sec), about 20 scfm (9.4×10⁻³ m³/sec), about 30 scfm (14.2×10⁻³ m³/sec), about 40 scfm (18.9×10⁻³ m³/sec), about 50 scfm (23.6×10⁻³ m³/sec), about 60, scfm (28.3×10⁻³ m³/sec), or any value or range between any two values including endpoints.

The first plasma reactor array 704 may be housed within a first double-walled, water-cooled reactor vessel or chamber 703. In one non-limiting example, the first reactor vessel may be a high-pressure vessel composed of steel. Carbon dioxide entering the first plasma reactor array 704 may be partially dissociated to form a mixture of constituents including one or more of CO₂, CO and O₂. The mixture of constituents, as a gas mixture, may pass through a refractory lined pipe section 705 that is fluidly connected to a feed chamber 706.

In one non-limiting embodiment of the system disclosed in FIG. 7, carbonaceous feed stock may not be placed in the feed chamber 706 until the feed chamber possesses the conditions necessary to support the reaction between the constituent gas and the carbonaceous feed stock. In a non-limiting example, carbonaceous feed material may be delivered from a feeder 7015 to the feed chamber 706 via a feed pipe 7016 after the feed chamber has attained a desired temperature. The desired temperature may be one in which the constituent gas and the carbonaceous feed stock may react to produce a desired combination of products in a gaseous mixture. In one non-limiting example, the desired temperature of the feed chamber 706 may be about 700° C. Examples of such a desired temperature may include, without limitation, about 100° C., about 300° C., about 500° C., about 1,000° C., about 3,000° C., about 5,000° C., about 10,000° C., or any value or range between any two values including endpoints. In one non-limiting embodiment, the feed chamber 706 may attain a desired temperature due to the temperature of the constituent gas generated by the first reaction vessel. In another non-limiting embodiment, the feed chamber 706 may attain a desired temperature due to a plasma reactor emitting a plasma field into the interior of the feed chamber. As a non-limiting example, a plasma field may be introduced into the interior of the feed chamber 706 and act directly on the carbonaceous feed stock.

The carbonaceous feed material may include any solid, liquid, or gaseous material that incorporates carbon or carbon containing compounds including, without limitation, one or more of municipal waste, coal, pet coke, agricultural waste, green waste, wood, and carbon dioxide. As aqueous solutions may also contain dissolved carbon dioxide, carbonaceous feed material may also include fresh water, salt water, and waste water. The carbonaceous feed material may react with the heated constituent gas stream from the first reactor vessel 703 to form a gaseous mixture. It may be understood that the composition of the gaseous mixture may depend, at least in part, on the composition of the carbonaceous feed material. Thus, without limitation, the gaseous mixture may be composed of one or more of carbon dioxide, carbon monoxide, methane, ethane, methanol, ethanol, water, hydrogen gas, oxygen gas, nitrogen gas, volatilized hydrocarbons, volatilized organic materials, and volatilized inorganic materials.

The gaseous mixture produced in the feed chamber 706 may be transferred via a second refractory lined pipe section 707 to a second reactor vessel 708 that includes a second plasma reactor array 709. In one non-limiting example, the second reactor vessel 708 may be a double-walled, water-cooled pressure vessel made of steel. The gaseous mixture transported into the second reactor vessel 708 may undergo additional partial dissociation due to contacting the plasma fields generated by the second plasma array 709. The plasma reaction with the gaseous mixture may result in an effluent stream that may be enriched in one or more constituents or have reduced amounts of one or more constituents. It may be understood that the gaseous mixture may be pre-treated before entering the second reactor vessel 708. Such pre-treatments may include removal of particulates, recapture of water, and other material processes.

The effluent stream produced by the second reactor vessel 708 may be transferred through a third pipe section 7011 in which the effluent constituent gases are cooled. The cooled effluent constituent gases may be transported to an off-gas cleaning system 7012. The off-gas cleaning system 7012 may be composed of particulate filters such as cyclones, fabric bags and/or packed-bed scrubbers to remove particulate material such as ash and acid gases such as HCl and H₂SO₄. After the effluent stream is cleaned, some portion of selected gases, such as O₂, CO, H₂, and N₂, as well as some portion of water may be removed from the effluent stream via membrane filtration or other molecular separation method, and stored in product storage devices 7013. Remaining gases may be recirculated back to the first reactor vessel 703 via pipe section 7014. It may be understood that some individual species may also be removed by similar filtration means from the gaseous mixture produced from the carbonaceous material in the feed chamber 706. Such species, filtered from the gaseous mixture, the effluent stream, or both the gaseous mixture and the effluent stream, may be stored in appropriate storage devices

It may be understood that the system and methods disclosed with respect to FIG. 7 may also include the use of one or more process controllers as discussed with respect to the system and methods disclosed with respect to FIGS. 5 and 6.

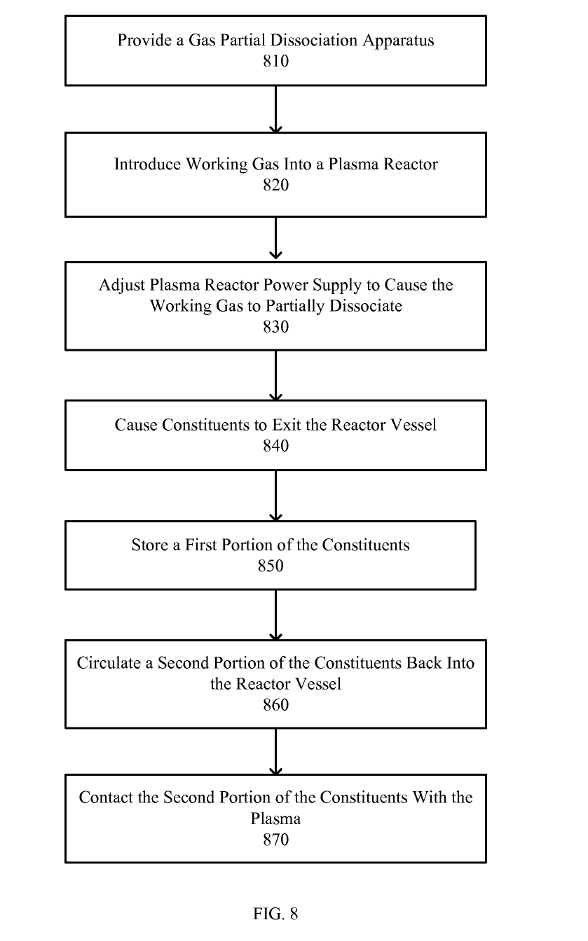

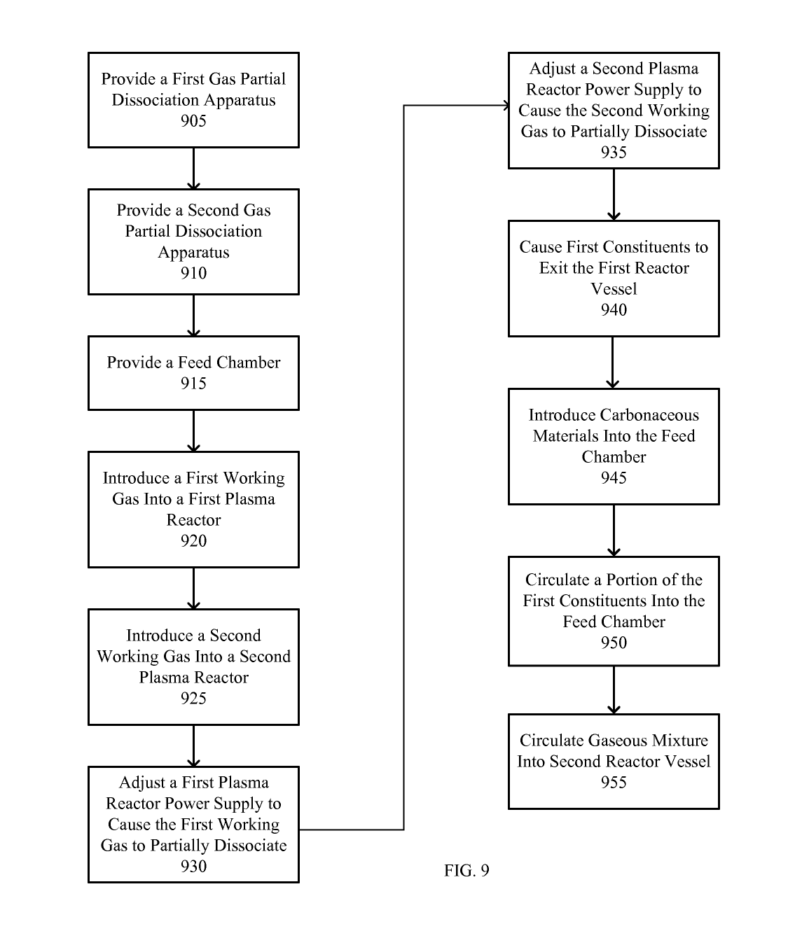

FIG. 8 is a flow diagram of an illustrative method for partial dissociation of gases. The method may include providing 810 an apparatus configured for partial dissociation of a gaseous material. The apparatus may include a reactor vessel having an inlet and an outlet, a plasma reactor such as a plasma torch, a power supply configured to place a voltage potential across a pair of electrodes or an electrode and a nozzle of the plasma torch, and a source of a working gas to be used with the plasma reactor. The working gas may be introduced 820 into the plasma reactor, and the power supply may be adjusted 830 to apply a voltage potential to the plasma torch to create an expanded plasma field. The plasma field may be composed of at least some partial dissociation constituents derived from the working gas. The constituents may be caused 840 to exit the reactor vessel by means of the vessel outlet. A first portion of the constituents may be separated into individual species and each of the individual constituent species may be stored 850 in a storage device. A second portion of the constituents may be circulated 860 back into the reaction vessel where it may enter through the reaction vessel inlet. The second portion may be caused to contact 870 the plasma field established within the reaction vessel by the plasma reactor. Additional constituents may be generated by the exposure of the second portion of the constituent species to the plasma field within the reaction vessel.

FIG. 9 is a flow diagram of an illustrative method for partial dissociation of gases and carbonaceous materials. The method may include providing 905 a first apparatus configured for partial dissociation of a gaseous material. The first apparatus may include a first reactor vessel having a first inlet and a first outlet, a first plasma reactor such as a plasma torch, a first power supply configured to place a voltage potential across a pair of electrodes or an electrode and a nozzle of the first plasma torch, and a source of a first working gas to be used with the first plasma reactor. The method may also include providing 910 a second apparatus configured for partial dissociation of a gaseous material, similar in construction to the first apparatus. Thus, the second apparatus may include a second reactor vessel having a second inlet and a second outlet, a second plasma reactor such as a plasma torch, a second power supply configured to place a voltage potential across a pair of electrodes or an electrode and a nozzle of the second plasma torch, and a source of a second working gas to be used with the first plasma reactor.

It may be understood that the first working gas and the second working gas may have the same composition or may have different compositions. It may also be understood that the source of the first working gas and the source of the second working gas may be the same source or they may be different sources. Similarly, the first power supply may be a separate and separately controllable power supply from the second power supply. Alternatively, the first and second power supply may constitute the same power supply configured to apply a voltage potential across the electrodes associated with the first plasma reactor and the electrodes associated with the second plasma reactor.

A feed chamber may be provided 915 to receive carbonaceous material from a carbonaceous material source. The feed chamber may be in fluid communication with the first reactor vessel via the first outlet and also in fluid communication with the second reactor vessel via the second inlet.

The first working gas may be introduced 920 into the first plasma reactor, and the second working gas may be introduced 925 into the second plasma reactor. As disclosed above, the first working gas and the second working gas may have the same composition or different compositions and may be supplied from the same gas source or separate gas sources. The first power supply may be adjusted 930 to apply a voltage potential to the first plasma reactor to create a first expanded plasma field. The first plasma field may be composed of at least some first partial dissociation constituents derived from the first working gas. The second power supply may be adjusted 935 to apply a voltage potential to the second plasma reactor to create a second expanded plasma field. The second plasma field may be composed of at least some second partial dissociation constituents derived from the second working gas. In some embodiments, a single power supply may be used to apply a first voltage potential across the electrode and nozzle of the first plasma reactor and a second voltage potential across the electrode and the nozzle of the second plasma reactor. The first voltage potential may be about the same as the second voltage potential or the first voltage potential may differ from the second voltage potential. As one example, the first voltage potential may have a first polarity and the second voltage potential may have a polarity opposite to the first voltage potential.

It may be understood that the first partial dissociation constituents and the second partial dissociation constituents may have the same composition or different compositions. In one non-limiting example, the first working gas introduced into the first plasma reactor may differ from the second working gas introduced into the second plasma reactor. The different working gases may result in differences in the composition of the first plasma field constituents and the second plasma field constituents. In another non-limiting example, the first working gas introduced into the first plasma reactor may be the same as the second working gas introduced into the second plasma reactor. However, the first partial dissociation constituents and the second partial dissociation constituents may differ in their compositions due to a difference between the electrode metal composition of the first plasma reactor and the electrode metal composition of the second plasma reactor. Further, the first partial dissociation constituents and the second partial dissociation constituents may differ in their compositions due to a difference between the electrode length of the first plasma reactor and the electrode length of the second plasma reactor. Additionally, the first partial dissociation constituents and the second partial dissociation constituents may differ in their compositions due to a difference between the voltage potential placed across the electrodes of the first plasma reactor and the voltage potential placed across the electrodes of the second plasma reactor.

The first constituents may be caused 940 to exit the first reactor vessel by means of the first outlet. In one non-limiting embodiment, the first constituents may pass through an empty feed chamber (that is, one not containing any carbonaceous material) and enter the second reactor vessel by means of the second inlet. The first constituents may contact the second plasma field in the second reactor vessel to create a gas having enhanced constituents beyond those that may be produced by the second plasma field alone. In one non-limiting example, the gas having enhanced constituents may have a greater amount of one constituent species (for example carbon monoxide gas) than a gas produced by the second plasma field alone. The gas composed of the enhanced constituents may be cooled, de-acidified, filtered, or otherwise manipulated, and portions of the individual enhanced constituent species may be either separately stored or returned to the first reactor vessel by the first inlet.

In another non-limiting example, an amount of carbonaceous material may be introduced 945 into the feed chamber. For example, the carbonaceous material may be introduced 945 into the feed chamber when the feed chamber attains a specific temperature or has a temperature within a particular range. Examples of such a temperature may include, without limitation, about 100° C., about 300° C., about 500° C., about 1,000° C., about 3,000° C., about 5,000° C., about 10,000° C., or any value or range between any two values including endpoints. At least a portion of the first constituents may be circulated 950 into the feed chamber. Under appropriate conditions, the first constituents may react with the carbonaceous materials in the feed chamber to form a gaseous mixture. The gaseous mixture that may arise from such a reaction may be composed of a number of chemical species including, without limitation, one or more of carbon dioxide, carbon monoxide, methane, ethane, methanol, ethanol, water, hydrogen gas, oxygen gas, nitrogen gas, volatilized hydrocarbons, volatilized organic materials, and volatilized inorganic materials.

In another non-limiting embodiment, the feed chamber may also comprise one or more plasma reactors that may produce a plasma field with the fee chamber interior. The plasma field generated within the feed chamber may act upon one or more of the constituent gas produced by the first reactor vessel and the carbonaceous feed stock.

The gaseous mixture from the feed chamber may be circulated 955 into the second reactor vessel. The gaseous mixture may thus contact the second plasma field generated by the second plasma reactor, resulting in alternative enhanced constituents that may exit the second reactor vessel as an off-gas. The off-gas constituents may be filtered, de-acidified, and separated into species for storage in storage devices or returned to the first reactor vessel for additional processing.

### EXAMPLES

### Example 1

### CO₂ and H₂O Partial Dissociation Based on Plasma Electrode and Nozzle Materials of Construction

Table I presents non-limiting examples of amounts of working gas material partially dissociated by a plasma reactor.

TABLE I

| | | | % Dissociated | | % Dissociated |
|---|---|---|---|---|---|
| Electrode/ | % Unreacted Species | | Species | | Species |
| Nozzle | (From Initial Material) | | (From CO₂) | | (From H₂O) |
| Material | CO₂ | H₂O | O₂ | CO | H₂ |
| Nickel | 20-30 | 85-90 | 10-15 | 60-80 | 10-15 |
| Tantalum | 45-50 | 75-80 | 20-30 | 25-30 | 15-20 |
| Tungsten | 30-40 | 80-90 | 40-50 | 30-40 | 10-20 |

Table I presents representative percentages of initial working gas components that remained under plasma field conditions, and percentages of working gas components partially dissociated under plasma field conditions for plasma reactors having different metal compositions for the electrode and/or nozzle. It may be noted that more carbon dioxide was retained in the constituent gas for plasma reactors having tantalum metal electrodes/nozzles than for plasma reactors having nickel or tungsten metal electrodes/nozzles. However, less water was retained in the constituent gas for plasma reactors having tantalum metal electrodes/nozzles than for plasma reactors having nickel or tungsten metal electrodes/nozzles. Carbon monoxide, as a partial dissociation constituent, was produced in a greater amount for plasma reactors having nickel metal electrodes/nozzles than for plasma reactors having tantalum or tungsten metal electrodes/nozzles. It may be appreciated that a partial dissociation apparatus intended for manufacturing syngas (a mixture of carbon monoxide and hydrogen) may benefit from the use of nickel metal electrodes/nozzles to optimize the production of carbon monoxide. Alternatively, a partial dissociation apparatus intended for manufacturing oxygen and hydrogen for industrial use may benefit from the use of tungsten metal electrodes/nozzles to optimize the production of oxygen.

### Example 2

### CO₂ Partial Dissociation Based on Plasma Electrode and Nozzle Materials of Construction

Table II presents non-limiting examples of amounts of carbon dioxide partially dissociated by a plasma reactor.

TABLE II

| Electrode/ | | % CO₂ | % CO₂ |
|---|---|---|---|
| Nozzle | % Unreacted | Dissociated | Dissociated |
| Material | CO₂ | Into CO | Into O₂ |
| Graphite | 35 | 23 | 42 |
| Nickel | 1 | 13 | 32 |
| Tantalum | 29 | 11 | 60 |
| Tungsten | 26 | 42 | 32 |

Table II presents representative percentages of initial carbon dioxide that remained under plasma field conditions, and percentages of carbon dioxide components partially dissociated under plasma field conditions for plasma reactors having different metal compositions for the electrode and/or nozzle. It may be observed that tantalum electrodes or nozzles produced the greatest amount of oxygen from the carbon dioxide, and may therefore be a preferred metal if oxygen is desired as an industrial product. Alternatively, the excess oxygen may be returned to one or more reactor vessels to produce an oxygen rich environment. In one example, an oxygen rich environment may be useful for improved reaction of carbonaceous feed stock to yield carbon monoxide and carbon dioxide off-gasses. Plasma reactors using graphite electrodes and/or nozzles may be useful to provide acceptable yields of oxygen and carbon monoxide while using inexpensive materials for the electrode and/or nozzle. Plasma reactors using nickel electrodes and/or nozzles appear useful in removing carbon dioxide from the plasma constituents.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated in this disclosure, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can, of course, vary. It is also to be understood that the terminology used in this disclosure is for the purpose of describing particular embodiments only, and is not intended to be limiting.

With respect to the use of substantially any plural and/or singular terms in this disclosure, those having skill in the art can translate from the plural to the singular and/or from the singular to the plural as is appropriate to the context and/or application. The various singular/plural permutations may be expressly set forth in this disclosure for sake of clarity.

It will be understood by those within the art that, in general, terms used in this disclosure, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed in this disclosure also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed in this disclosure can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. From the foregoing, it will be appreciated that various embodiments of the present disclosure have been described for purposes of illustration, and that various modifications may be made without departing from the scope and spirit of the present disclosure. Accordingly, the various embodiments disclosed are not intended to be limiting, with the true scope and spirit being indicated by the following claims.

1. An apparatus comprising:
a reactor vessel having an inlet and an outlet;
a plasma reactor having a divergent electrode and a divergent nozzle, wherein the divergent nozzle is in fluid communication with an interior of the reactor vessel;
a power supply in electrical communication with the divergent electrode and the divergent nozzle configured to apply a voltage potential across the divergent electrode and the divergent nozzle; and
a plasma reactor working gas source configured to supply a working gas to the plasma reactor,
wherein the power supply is configured to apply a voltage potential across the divergent electrode and the divergent nozzle to partially dissociate the working gas.

2. The apparatus of claim 1, wherein the plasma reactor comprises one or more plasma torches.

3. The apparatus of claim 1, wherein the divergent electrode and divergent nozzle are independently chosen from a nickel metal, a tantalum metal, a tungsten metal, a graphite material, or any alloy or combination thereof.

4. The apparatus of claim 1, wherein the power supply is configured to apply a voltage potential having a power of about 200 kW to about 1 MW across the divergent electrode and the divergent nozzle.

5. The apparatus of claim 1, wherein the working gas comprises carbon dioxide, water, or any combination thereof.

6. The apparatus of claim 1, further comprising a second reactor vessel having a second inlet, a second outlet, and a second plasma reactor having a second divergent electrode and a second divergent nozzle, wherein the second divergent nozzle is in fluid communication with an interior of the second reactor vessel.

7. The apparatus of claim 6, wherein the second inlet of the second reactor vessel is in fluid communication with the outlet of the reactor vessel, and the second outlet of the second reactor vessel is in fluid communication with the inlet of the reactor vessel.

8. The apparatus of claim 6, further comprising a feed chamber configured to receive one or more carbonaceous materials, wherein the feed chamber is in fluid communication with the reactor vessel and the second reactor vessel.

9. The apparatus of claim 8, wherein the carbonaceous material comprises one or more of municipal waste, coal, pet coke, agricultural waste, green waste, wood, carbon dioxide, fresh water, salt water, and waste water.

10. The apparatus of claim 8, wherein the feed chamber further comprises at least a third plasma reactor having a third divergent electrode and a third divergent nozzle, wherein the third divergent nozzle is in fluid communication with an interior of the feed chamber.

11. The apparatus of claim 1, further comprising one or more of a particulate removal device and an acid removal device.

12. The apparatus of claim 1, further comprising one or more of a cyclonic precipitator and a fabric bag.

13. The apparatus of claim 1, further comprising a packed-bed acid scrubber.

14. The apparatus of claim 1, further comprising:
a gas storage device in fluid communication with a gas separation device on a first side, wherein the outlet is in fluid communication with the gas separation device on a second side; and
a water recovery device in fluid communication with the outlet.

15. The apparatus of claim 1, further comprising a gas ring disposed between the divergent electrode and divergent nozzle.

16. A method, comprising:
providing an apparatus comprising:
a reactor vessel having an inlet and an outlet,
a plasma reactor having a divergent electrode and a divergent nozzle, wherein the divergent nozzle is in fluid communication with an interior of the reactor vessel,
a power supply in electrical communication with the divergent electrode and the divergent nozzle, and
a plasma reactor working gas source;
introducing the working gas from the working gas source into the plasma reactor;
adjusting the power supply to apply a voltage potential across the divergent electrode and the divergent nozzle, thereby causing the working gas to partially dissociate and generate a plasma comprising a plurality of constituents within the reactor vessel;
causing the plurality of constituents to exit the reactor vessel through the outlet;
storing a first portion of the plurality of constituents in one or more constituent storage devices;
circulating a second portion of the plurality of constituents into the inlet of the reactor vessel; and
contacting the second portion of the plurality of constituents with the plasma.

17. The method of claim 16, wherein an amount of any one of the constituents in the plasma depends at least in part on a material composition of the divergent electrode, the divergent nozzle, or the divergent electrode and the divergent nozzle.

18. The method of claim 17, wherein the material composition comprises one or more of a nickel metal, a tantalum metal, a tungsten metal, a graphite material, or any alloy or combination thereof.

19. The method of claim 16, wherein the working gas is carbon dioxide, the divergent electrode and the divergent nozzle both comprise nickel metal, and the plasma comprises about 60% to about 80% carbon monoxide.

20. The method of claim 16, wherein the working gas is carbon dioxide, the divergent electrode and the divergent nozzle both comprise tantalum metal, and the plasma comprises about 45% to about 50% carbon dioxide.

21. The method of claim 16, wherein the working gas is carbon dioxide, the divergent electrode and the divergent nozzle both comprise tungsten metal, and the plasma comprises about 40% to about 50% oxygen.

22. The method of claim 16, wherein the working gas is a mixture of water and carbon dioxide, the divergent electrode and the divergent nozzle both comprise tantalum metal, and the plasma comprises about 15% to about 20% hydrogen.

23. The method of claim 16, further comprising orienting a long axis of the plasma in the reactor vessel at an angle with respect to an inner surface of the reactor vessel.

24. The method of claim 23, wherein the angle is about 90°.

25. The method of claim 23, wherein the angle is an acute angle.

26. The method of claim 16, wherein the apparatus comprises a plurality of plasma reactors.

27. The method of claim 26, further comprising:
introducing the working gas into each of the plurality of plasma reactors;
adjusting one or more power supplies to apply a voltage potential across a divergent electrode and a divergent nozzle of each of the plurality of plasma reactors, thereby causing the working gas in each of the plurality of plasma reactors to partially dissociate into a plasma.

28. The method of claim 27, further comprising orienting a first plasma generated by a first plasma reactor and orienting a second plasma generated by a second plasma reactor to cause the first plasma to interact with the second plasma.

29. The method of claim 27, wherein a first voltage potential applied across a first divergent electrode and a first divergent nozzle of a first plasma reactor is opposite a second voltage potential applied across a second divergent electrode and a second divergent nozzle of a second plasma reactor.

30. The method of claim 16, further comprising:
removing an amount of material from the one or more constituent storage devices; and
contacting the amount of material removed from the one or more constituent storage devices with the plasma.

31. A method comprising:
providing a first apparatus comprising:
a first reactor vessel having a first inlet and a first outlet,
a first plasma reactor having a first divergent electrode and a first divergent nozzle, wherein the first divergent nozzle is in fluid communication with an interior of the first reactor vessel,
a first power supply in electrical communication with the first divergent electrode and the first divergent nozzle, and
a first plasma reactor working gas source;
providing a second apparatus comprising:
a second reactor vessel having a second inlet and a second outlet, wherein the second inlet is in fluid communication with the first outlet and the second outlet is in fluid communication with the first inlet,
a second plasma reactor having a second divergent electrode and a second divergent nozzle, wherein the second divergent nozzle is in fluid communication with an interior of the second reactor vessel,
a second power supply in electrical communication with the second divergent electrode and the second divergent nozzle, and
a second plasma reactor working gas source;
providing a feed chamber in fluid communication with the first outlet and the second inlet;
introducing a first working gas from the first working gas source into the first plasma reactor;
introducing a second working gas from the second working gas source into the second plasma reactor;
adjusting the first power supply to apply a first voltage potential across the first divergent electrode and the first divergent nozzle, thereby causing the first working gas to partially dissociate and generate a first plasma comprising a first plurality of constituents within the first reactor vessel;
adjusting the second power supply to apply a second voltage potential across the second divergent electrode and the second divergent nozzle, thereby causing the second working gas to partially dissociate and generate a second plasma comprising a second plurality of constituents within the second reactor vessel;
causing the first plurality of constituents to exit the first reactor vessel through the first outlet;
introducing a carbonaceous material into the feed chamber;
circulating a portion of the first plurality of constituents into the feed chamber, thereby contacting the carbonaceous material with the first plurality of constituents to form a gaseous mixture; and
circulating the gaseous mixture into the second reactor vessel, thereby contacting the gaseous mixture with the second plasma to form an effluent stream.

32. The method of claim 31, wherein the carbonaceous material comprises one or more of municipal waste, coal, pet coke, agricultural waste, green waste, wood, and carbon dioxide.

33. The method of claim 31, further comprising:
removing particulates from the gaseous mixture, the effluent stream, or the gaseous mixture and the effluent stream;
removing acidic constituents from the gaseous mixture, the effluent stream, or the gaseous mixture and the effluent stream; and
storing a portion of constituents of the gaseous mixture, constituents of the effluent stream, or constituents of the gaseous mixture and constituents of the effluent stream in one or more constituent storage devices.
